(19) United States
(12) Patent Application Publication
(10) Pub. No.: US 2026/0092777 A1
(43) Pub. Date: Apr. 2, 2026

(54) SYSTEM AND METHOD FOR IDENTIFICATION OF ARCHEOLOGICAL FEATURES USING REMOTELY SENSED DATA

(71) Applicant: Nicholas A. Kuncewicz, Winnipeg (CA)

(72) Inventor: Nicholas A. Kuncewicz, Winnipeg (CA)

(21) Appl. No.: 19/347,382

(22) Filed: Oct. 1, 2025

Related U.S. Application Data
(60) Provisional application No. 63/701,871, filed on Oct. 1, 2024.

(51) Int. Cl. G01C 15/00; G06N 20/00

(52) U.S. Cl. CPC G01C 15/00; G06N 20/00

(57) ABSTRACT

This invention relates to a system and method for non-invasive detection of gravesites and archaeological features using multimodal remote sensing and machine learning. Remotely sensed datasets, including RGB, multispectral, hyperspectral, LiDAR, and thermal imagery, are orthorectified, mosaicked, and subdivided into tiled image segments. Features are labeled through manual annotation of visible markers and environmental signatures and expanded via iterative augmentation. A supervised pipeline trains computer vision models, such as YOLO-based detectors, in parallel with tabular models derived from spectral indices (NDVI, NDRE), LiDAR elevation derivatives, and thermal anomalies. Inference outputs are cross-validated against thresholded evidence layers to reject false positives and upgraded when spectral, spatial, and thermal evidence align. Validated detections are exported as GIS-compatible layers with confidence scores and metadata. The system provides a scalable, replicable tool supporting archaeologists, Indigenous communities, and planners in cemetery investigations, cultural resource management, and humanitarian searches for unmarked or clandestine graves.

This application claims the benefit under 35 U.S.C. 119(e) of U.S. provisional application Ser. No. 63/701,871, filed Oct. 1, 2024.

### FIELD OF THE INVENTION

The present invention relates to a method and apparatus for the identification of archeological features, for example gravesites, using one or more remotely sensed datasets, for example remotely sensed images and the like, as an input.

### BACKGROUND

Archaeological prospection and cemetery investigations require methods that can balance cultural sensitivity with scientific accuracy. Excavation, while definitive, is frequently intrusive, time-consuming, and unacceptable in many cultural contexts. Traditional ground surveys are often slow and impractical when applied at scale, particularly in landscapes that demand minimal disturbance. The need for non-invasive yet reliable methods has become increasingly urgent, particularly in relation to community-led reconciliation initiatives, heritage preservation, and humanitarian investigations of unmarked or clandestine graves.

### SUMMARY OF THE INVENTION

According to one aspect of the invention there is provided a method of identifying an archeological feature of interest in an area of ground, the method comprising:
acquiring one or more remotely sensed datasets representing said area of ground;
creating a representative map of said area of ground from the one or more remotely sensed datasets in which the representative map comprising an array of representative values which represent a measured characteristic at a respective coordinate of said area of ground;
comparing clusters of the representative values which are similar to one another to feature criteria to determine if the clusters each represent the archeological feature of interest; and
marking the clusters determined to be archeological features of interest on a map for display to a user.

The method may further include generating a display map of said area of ground including an indication of each cluster identified as the archeological feature of interest on the display map.

The archeological feature of interest according to the illustrated embodiment is a gravesite.

According to one embodiment, the remotely sensed datasets comprise multispectral images and said representative map comprise a pixel map defining a pixel at each coordinate, the method further comprising creating said representative map by calculating a vegetation index in which each pixel from the pixel map defines a reflectance value associated with the pixel, and comparing said clusters to said feature criteria to determine if the clusters each represent the archeological feature of interest by: (i) for each pixel, comparing the reflectance value to a reflectance threshold and determining the pixel to be a qualifying pixel if the reflectance threshold is met or a non-qualifying pixel if the threshold is not met; (ii) identifying clusters of adjacent qualifying pixels; and (iii) comparing each cluster of adjacent qualifying pixels to a size threshold and determining the cluster to be a gravesite if the size threshold is met or to be a non-gravesite if the size threshold is not met.

In this instance, the vegetation index may comprise (i) NDVI (Normalized Difference Vegetation Index), a normalized reflectance index empirically validated to exhibit elevated mean values over gravesites compared to background vegetation, (ii) NDRE (Normalized Difference Red Edge), an index sensitive to nitrogen enrichment and chlorophyll density, validated as a reliable proxy for vegetation anomalies associated with graves or (iii) both NDVI and NDRE, the combined indices providing a dual measure of vegetation vigor and nutrient enrichment that increases stability and reduces false positives in burial detection.

The method may further include adjusting the reflectance thresholds dynamically during validation, wherein augmentation includes variable lighting, vegetation state, and terrain distortion.

The method may further include calculating the size threshold based on a ground sampling distance associated with the acquired images.

The method may further include selecting the size threshold among a plurality of different size thresholds associated with different burial dimensions.

The method may further include creating the pixel map by stitching together a plurality of the acquired images associated with different sections of said area of ground.

The method may further include calculating a total number of graves within said area of ground by dividing a number of the qualifying pixels in clusters by a unit value representative of a size of a single grave.

The method may further include selecting the unit value among a plurality of different unit values associated with different corpse sizes.

The method may further include calculating the total number of graves within said area of ground using a frequency distribution of the average reflectance of vegetation within a human grave plotted on a histogram by dividing the frequency by the unit value which represents an average feature size.

The method may further include calculating burial density by plotting the average reflectance of vegetation associated with gravesites on a histogram and dividing the frequency distribution by a unit value representing average feature size.

The statistical measurements for estimating burial density may comprise NDVI, NDRE or both NDVI and NDRE enabling enhanced stability in quantifying burial densities.

According to a further embodiment, the remotely sensed datasets comprise remotely sensed elevation data comprising a discrete set of data points in space defining the area of ground in Cartesian coordinates comprising an elevation, a latitude, and a longitude associated with each data point, in which the method further comprises creating said representative map by filtering the set of data points to remove any data points determined to be non-ground points based on an anomalous elevation and replacing the removed data points within the set of data points with replacement data points representing true ground, and comparing said clusters to said feature criteria to determine if the clusters each represent the archeological feature of interest by: (i) for each data point of the set of data points, calculating a plurality of elevation attributes that define a relationship between the elevation of the data point and the elevation of laterally and longitudinally adjacent data points; (ii) clustering data points having similar elevation attributes into clusters; and (iii) comparing each cluster to a size threshold and determining the cluster to be a gravesite if the size threshold is met or to be a non-gravesite if the size threshold is not met.

The method may further comprise acquiring LiDAR point cloud data of the area of ground, classifying ground points, rasterizing into elevation models, and calculating elevation attributes including hillshade, slope gradient, skyview factor, and openness, clustering anomalies consistent with burial features, and validating said anomalies in combination with spectral and thermal detections.

The method may further comprise determining data points to be non-ground points when the elevation is above an upper threshold or below a lower threshold.

The replacement data points representing true ground may be calculated by interpolating the elevations from laterally and longitudinally adjacent data points.

The method may further comprise rasterizing the set of data points prior to calculating the elevation attributes.

The method may further comprise filtering the set of data points to remove any data points determined to be non-ground points by applying a cloth simulation filter.

The method may further comprise optimizing a cloth resolution, a maximum number of iterations, and a classification threshold of the cloth simulation filter to distinguish the gravesites from surrounding ground.

The method may further comprise setting a cloth resolution of the cloth simulation filter to be between 0.4 and 0.6, setting a maximum number of iterations of the cloth simulation filter to be between 600 and 900, and setting a classification threshold of the cloth simulation filter to be between 0.8 and 1.2.

The elevation attributes may include environmental attributes such as shading, gradient and openness of the data point relative to adjacent data points, for example hillshade, slope gradient, skyview factor, and/or positive or prismatic openness.

The method may further comprise applying a verification filter by comparing the clusters to non-anomalous objects and removing any clusters identified as non-anomalous objects before marking the clusters on the map.

According to a further aspect of the present invention the datasets may comprise at least one of RGB, multispectral, hyperspectral, LiDAR, thermal, or satellite imagery, whether captured directly or obtained from external sources, in which the step of comparing said clusters to said feature criteria to determine if the clusters each represent the archeological feature of interest further comprises: (i) preprocessing the datasets into orthorectified and tiled image segments suitable for machine learning workflows; (ii) training a machine learning pipeline to classify identified archaeological features in the datasets, the pipeline being configured to integrate visual information with statistical measurements derived from spectral, spatial, and thermal data; (iii) performing inference on new datasets to automatically identify probable gravesites and archaeological features; (iv) cross-validating detections against statistical thresholds and elevation or thermal anomalies; and (v) marking said clusters determined to be archeological features of interest on a map for display to a user by generating geospatial outputs marking validated features.

The method may further comprise importing the tiled datasets into annotation software, wherein human operators manually label regions of interest such as visible markers, vegetation anomalies, or surface depressions to generate ground-truth datasets for supervised machine learning.

The method may further comprise applying iterative augmentation to the labeled datasets, the augmentation including transformations selected from: horizontal flips, affine rotations within a range of −25 to +25 degrees, rescaling between 0.9 and 1.1, brightness variation between 0.8 and 1.2, contrast variation between 0.8 and 1.2, Gaussian noise addition with scale between 5 and 15, Gaussian blur with sigma between 0.0 and 1.0, and grayscale conversion applied with a probability of 30 percent.

The method may further comprise dividing the augmented datasets into training, validation, and testing subsets, wherein the subsets are used in a supervised learning workflow to optimize object detection accuracy and reduce model overfitting.

The method may further comprise training a machine learning model using the training subset, validating against the validation subset, and refining detection accuracy over multiple training-validation cycles, in which the model is configured to integrate RGB-derived features in combination with statistical tabular data including but not limited to multispectral or hyperspectral indices, LiDAR-derived height rasters, and thermal radiometric measurements.

According to another aspect of the present invention there is provided an apparatus for identifying archeological features in an area of ground, the apparatus comprising: (i) a data source arranged to acquire one or more remotely sensed datasets representing said area of ground; and (ii) a computer system comprising a processor and a memory storing programming instructions thereon arranged to be executed by the processor so as to be configured to perform any aspect of the method described above.

Recent advances in remote sensing and artificial intelligence now make such methods possible. High-resolution aerial imaging, multispectral and hyperspectral analysis, LiDAR-based terrain modeling, and thermal sensing can all capture subtle environmental signatures left by gravesites and archaeological features. Vegetation growth, soil chemistry, microtopography, and soil temperature create measurable anomalies that, when interpreted systematically, reveal patterns associated with human activity and burial. What is especially significant is that many of these measurements are normalized—such as NDVI and NDRE—meaning that they provide consistent, globally transferable indicators of burial-related vegetation stress and enrichment regardless of local lighting or climate conditions.

The system outlined in this document, System and Method for Gravesite and Archaeological Site Identification Using Remotely Sensed Data and Machine Learning, formalizes these advances into a coherent, repeatable workflow. It integrates multiple sensing modalities—multispectral imaging, LiDAR, thermal sensing, and RGB photogrammetry—within a machine learning framework capable of detecting, classifying, and validating features linked to gravesites and archaeological structures. By synthesizing computer vision with statistically validated spectral and spatial thresholds, the system achieves a level of reliability not possible through single-sensor methods alone.

This work is driven by both a technical opportunity and a moral responsibility. The search for unmarked graves and archaeological features is not only a scientific challenge but also a societal obligation to communities seeking truth, reconciliation, and cultural preservation. Methods must therefore be designed to reduce human bias, minimize physical disturbance, and maximize interpretability for stakeholders ranging from Indigenous communities to academic researchers, municipal planners, and humanitarian agencies.

The system described here is designed to do more than demonstrate technical feasibility: it provides a roadmap for scalable deployment. Its modular architecture allows operation at multiple levels, from single-site cemetery investigations to large-scale regional surveys, adapting the complexity of data inputs (RGB-only through to full multi-modal integration) to the needs of the project. Applications extend from archaeological research and cultural heritage management to Indigenous community-led searches, humanitarian investigations in post-conflict zones, and infrastructure planning where archaeological assessments are legally mandated.

In this sense, the document serves two purposes: it provides a technical explanation of the invention and establishes its scientific and ethical grounding as a transformative tool. It demonstrates novelty by combining field-proven workflows with machine learning innovation, and it underscores impact by situating the system at the intersection of archaeology, heritage protection, and social responsibility.

The foundation of this invention lies in the integration of modern remote sensing technologies, each of which contributes a unique and complementary perspective on the landscape. Burials and archaeological features leave subtle but measurable signatures in vegetation, soils, and terrain. By drawing on multiple sensing modalities, these signals can be systematically captured, quantified, and interpreted.

Spectral Imaging is central to this process. This enables the detection of vegetation anomalies that are invisible to the human eye but closely linked to soil chemistry and nutrient enrichment caused by decomposition. Indices such as NDVI (Normalized Difference Vegetation Index) and NDRE (Normalized Difference Red Edge) provide normalized, dimensionless measures of plant vigor and nitrogen status. These indices have consistently shown elevated values over graves when compared to background vegetation zones.

Importantly, because they are normalized ratios of reflectance, NDVI and NDRE values are transferable across sites and climates, making them globally applicable. The proof-of-concept and subsequent analysis demonstrated that graves typically exhibit NDRE mean values in the approximate range of 0.14-0.25 and NDVI mean values in the approximate range of 0.59-0.70, with some flexibility expected across environmental contexts. This elevated spectral response is thought to reflect enriched soil conditions, particularly increased nitrogen availability, which enhances chlorophyll production and drives higher reflectance in red-edge and near-infrared bands.

LiDAR (Light Detection and Ranging) provides a complementary perspective by capturing dense three-dimensional point clouds of the earth's surface. These data are processed into digital elevation models (DEMs), hillshades, and openness metrics, revealing microtopographic features often invisible on the ground. Burial depressions, subtle mounding, or irregular slope patterns can all serve as indicators of past interments or archaeological activity. LiDAR is particularly powerful because it detects structural features directly rather than relying on vegetation proxies.

Thermal Sensing adds another layer by capturing differences in soil heat retention, irradiance, and emissivity. Disturbed soils, including graves, often cool or warm at different rates than undisturbed areas due to differences in compaction, porosity, and moisture content. These thermal anomalies provide independent confirmation of burial-related disturbances, particularly when cross-validated with spectral and elevation data.

RGB Photogrammetry functions both as a standalone modality and as the integrating layer of the system. High-resolution RGB imagery provides detailed orthomosaics and 3D reconstructions, serving as a geospatial anchor for aligning multispectral, LiDAR, and thermal datasets. Beyond this reference role, RGB imagery also contributes to the machine learning process by supplying clear basemaps for annotation and augmentation. By systematically varying color balance, orientation, and scale, RGB datasets generate synthetic training examples that enhance the generalization capacity of object detection models.

Taken together, these technologies create a multi-modal detection framework. Each modality is individually reliable and provides valuable signals, but when integrated they reinforce one another, reduce false positives, and increase stability under varied environmental conditions. The combination of spectral enrichment (NDVI/NDRE), topographic change (LiDAR), and thermal variation offers a comprehensive approach to non-invasive detection that exceeds the limitations of any single-sensor method.

The machine learning model (MLM) builds on this foundation. High-level training modules, including YOLOv8 and supplementary convolutional neural networks, iteratively learn to detect and classify burial-associated features. Each cycle of training improves model accuracy by combining visual object recognition with statistically validated thresholds from remote sensing data. In this synthesis, the statistical strength of normalized indices (RGB augmentation, NDVI/NDRE ranges, LiDAR slope thresholds, thermal anomalies) is fused with the pattern-recognition capability of deep learning, producing a system that balances empirical grounding with computational intelligence. This convergence of computer vision and statistical modeling reflects what can be described a gestalt of environment, technology, and interpretation.

Training datasets for this system have been derived from multiple contexts, including archaeological fur trade sites in Manitoba and several small municipal cemeteries. These sites provide both burial and non-burial features for annotation, allowing the model to learn distinctions between graves and other cultural features such as bastions, palisade walls, hearths, pits, middens, cellars, and blacksmithing areas; and will also cover pre-contact site features including lithic scatters and high-value areas such as caches, rock outcrops, vantage points for defensive position and hunting. By including both funerary and occupational archaeological features, the system is designed not only for gravesite identification but also for broader applications in heritage management and infrastructure planning.

Remote sensing technologies therefore serve two roles: first, as data sources for detecting specific signatures of burials and archaeological features; and second, as training material for machine learning models that can automate and scale detection. The result is a robust, flexible, and transferable foundation that anchors the invention's novelty and positions it as a transformative tool in non-invasive prospection.

### BRIEF DESCRIPTION OF THE DRAWINGS

Some embodiments of the invention will now be described in conjunction with the accompanying drawings in which:

FIG. 1 schematically represents different remotely sensed datasets (RGB, multispectral, hyperspectral, LiDAR, thermal, satellite) feeding into a unified AOI pixel map.

FIG. 2 schematically represents tiling and illustrates orthorectification and subdivision of an AOI into indexed analysis tiles.

FIG. 3 schematically represents a detection workflow showing RGB tile input, bounding box overlay, and validated detections.

FIG. 4 illustrates qualifying pixels, clustering, and size thresholding showing progression from spectral tile to thresholded pixels, clusters, and final gravesite labels.

FIG. 5 schematically represents a ROI pixel cluster with bounding box illustrating annotation logic where an ROI is represented by a group of adjacent pixels enclosed by a bounding box.

FIG. 6 schematically represents labeled examples (nadir views) illustrating ROI representations across modalities: headstone (visible marker), vegetation anomaly (NDVI/NDRE), and surface depression (LiDAR).

FIG. 7 schematically represents dual augmentation pathways showing visual and statistical augmentation flows into independent models, with optional fusion prior to inference and validation.

FIG. 8 schematically represents fusion and validation logic illustrating model detections compared against binary evidence masks (NDRE, LiDAR, thermal), with accepted and rejected results.

FIG. 9 schematically represents an augmentation yield curve showing detection performance improvements across baseline, tuned augmentation, and augmentation with new datasets, demonstrating accelerating functional gains.

### DETAILED DESCRIPTION

The invention disclosed herein provides a computer-implemented method and apparatus for the automatic detection and digital marking of archaeological features of interest within an area of ground, a capability that until now has required extensive manual interpretation, invasive testing, or costly survey campaigns. The invention transforms measurements of the real world into a fully digital analytical product inside a computer system, where those measurements are ingested, parsed, organized, and interpreted by machine learning models executing instructions stored in memory. The method is carried out primarily within the computer: the system receives remotely sensed datasets as inputs, organizes them into structured digital arrays, compares clusters of representative values against feature criteria, and then defines and marks features automatically on a geospatial map. The result is not merely a static visualization but a functional, exportable tool—a trained and iteratively improved machine learning model—that can be applied to maps again and again to identify archaeological features of interest, including but not limited to gravesites, burial rows, headstones, crosses, postholes, bastions, mounds, hearths, middens, cellars, smithing areas, or other cultural structures. While the scope of the invention encompasses a wide variety of archaeological contexts, graves are emphasized as the primary example, both because of their cultural significance and because they have proven to yield consistent and detectable signals across multiple sensing modalities.

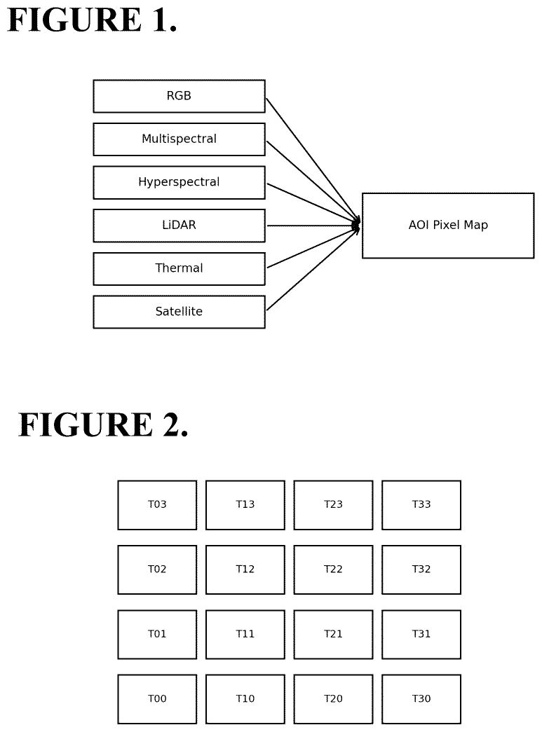

The operation begins with the ingestion of one or more remotely sensed datasets representing the area of ground under investigation. As shown in FIG. 1, these datasets may be collected using unmanned aerial systems, manned aircraft, satellite platforms, or other sensors capable of recording measurable properties of the surface or near-subsurface environment. The important distinction is that these inputs are not treated by the invention as photographs or abstract images; rather, they are structured as digital pixel maps, where each pixel carries a representative value corresponding to a physical measurement taken at a precise geographic coordinate. Along with the pixel values, each dataset carries embedded metadata specifying acquisition time, coordinate reference system, ground sampling distance, band composition, and sensor details. This metadata is not incidental but essential, because it allows the computer to situate every pixel in its correct geospatial context. The processor, executing stored instructions, reads these datasets into memory, parses their metadata, and organizes the measurements into structured arrays that can be addressed, aligned, and analyzed computationally.

At this stage, the invention uses what is referred to as the Area of Investigation (AOI) pixel map. The AOI pixel map is the first major digital component of the system, and it should not be misunderstood as a visualization alone. It is a structured digital array in memory, created by the computer to transform physical ground measurements into machine-readable form. Each element in the array corresponds to a ground coordinate and remotely sensed metadata within the AOI and holds a representative value encoding a measured characteristic. For example, in RGB datasets the representative values may be red, green, and blue intensities; in multispectral or hyperspectral datasets the values may be reflectance in near-infrared or red-edge bands; in LiDAR datasets the values may be elevation measurements interpolated from point clouds into rasters such as digital elevation models (DEMs) or digital terrain models (DTMs); and in thermal datasets the values may be emissivity or surface temperature. Each pixel is therefore both a coordinate and a measurement. Collectively, the AOI pixel map represents a complete digital construct of the ground—a numerical facsimile of the physical AOI upon which the system can apply statistical reasoning, clustering, and pattern recognition.

Because Areas of Investigation may cover vast geographic extents and include millions or even billions of pixels, the processor subdivides the AOI pixel map into tiled image segments. This subdivision, illustrated schematically in FIG. 2, creates smaller, uniformly sized sub-arrays labeled T00, T01, and so on. The processor executes instructions to cut the AOI pixel map into these tiles, and for each tile it writes metadata including tile identifier, bounding coordinates, pixel resolution, band composition, and acquisition provenance. Tiling is essential to the operation of the invention because convolutional neural networks expect inputs of fixed size. Tiling also allows batch processing, where many tiles can be passed through the pipeline in parallel, taking advantage of GPU acceleration. Equally important, tiling preserves geospatial traceability. When the system later detects a feature inside a tile, the metadata ensures that the feature can be back-projected precisely into the AOI coordinate space. Thus, tiling serves two functions: computational efficiency and geospatial integrity.

Once the AOI pixel map is subdivided into tiles, the invention proceeds to the creation of annotations, which provide the ground-truth examples necessary for supervised learning. Human operators, using labeling software such as Label Studio, review the tiled arrays and draw regions of interest around known or suspected features. For example, a polygon may be drawn around a headstone visible in RGB imagery, a bounding box may be drawn around a vegetation anomaly evident in multispectral indices, or a free-form outline may be traced around a shallow depression revealed in LiDAR-derived raster maps. Each annotation is stored digitally with a class label such as “grave marker,” “grave shaft,” or “archaeological structure,” and is linked to the tile metadata and through it back to the AOI. An annotation is not just a drawing but a precise digital record of coordinates and labels embedded in the structured arrays of the AOI pixel map. Collectively, these annotations form the ground-truth dataset, which is the foundation upon which the system learns to distinguish features of interest from background variability.

With the ground-truth dataset assembled, the invention initiates the augmentation process. At this stage, the computer system deliberately transforms the annotated samples to simulate real-world variability. The processor executes augmentation functions such as horizontal flipping to simulate changes in azimuth, small rotations to mimic flight path differences, rescaling to reflect variations in altitude or ground sampling distance, brightness and contrast adjustments to emulate solar angle and atmospheric differences, Gaussian noise and blur to simulate sensor imperfections, and occasional grayscale conversion to force reliance on shape and edge geometry rather than colour. Each augmentation creates a new training example derived from an existing annotation, and each new example is stored in memory alongside the originals. The result is a greatly expanded dataset that is far more representative of the range of conditions encountered in practice.

What is unique to this invention is that the augmentation-driven iterative training produces a super-linear improvement in detection accuracy. When the models are exposed to augmented data, the learning curve does not increase slowly or linearly, as is typical of conventional systems. Instead, it accelerates along a parabolic trajectory. Each additional batch of augmented examples yields disproportionately greater improvements in accuracy and robustness. This phenomenon, demonstrated in practice and conceptually depicted in FIG. 9, is a critical technical effect and a component function of artificial intelligence (AI) systems called Machine-Learning (ML). It means that the system learns faster, generalizes better, and achieves reliable performance with fewer unique acquisitions than would otherwise be required. This Machine-Learning-Model (MLM) is made possible by a function called computer-vision. This augmentation-driven parabolic learning curve, combined with the structured AOI pixel map, constitutes the dual cornerstone of the invention. The AOI pixel map provides the computer with a structured digital foundation for analysis, and the augmentation loop propels the models along an accelerated path of improvement.

Once augmentation is applied, the dataset is partitioned into three subsets: training, validation, and testing. The training subset is used to update neural network weights through repeated exposures to annotated and augmented examples. The validation subset, withheld from training, is used periodically to adjust hyperparameters and monitor generalization. The testing subset remains unseen until training is complete, providing an unbiased measure of performance. By enforcing this tripartite structure, the invention ensures that models do not merely memorize tiles but instead learn transferable patterns, and that reported metrics are accurate reflections of the system's true capability.

Once augmentation is applied, the dataset is partitioned into three subsets: training, validation, and testing. The training subset is used to update neural network weights through repeated exposures to annotated and augmented examples. The validation subset, withheld from training, is used periodically to adjust hyperparameters and monitor generalization. The testing subset remains unseen until training is complete, providing an unbiased measure of performance. By enforcing this tripartite structure, the invention ensures that models do not merely memorize tiles but instead learn transferable patterns, and that reported metrics are accurate reflections of the system's true capability.

At this point in the operation, the computing system holds not only the digital constructs necessary for learning but also the framework for iterative refinement. The processor initiates repeated training cycles in which tiles are fed forward through convolutional neural networks, loss functions are calculated, and weights are updated via backpropagation. Each cycle is monitored by evaluating predictions on the validation subset. If accuracy improves, weights are retained; if accuracy stagnates or declines, hyperparameters are adjusted. The system may implement dynamic learning rate schedules, early stopping to prevent overfitting, or confidence threshold calibration to balance sensitivity and precision. These procedures, executed entirely within the computing environment, ensure that the trained models converge toward a stable configuration optimized for detecting archaeological features within the AOI.

During this training phase, the invention accommodates multiple model architectures and fusion strategies. In one embodiment, visual information derived from RGB or multispectral imagery is processed by convolutional neural networks such as YOLO-family detectors implemented in PyTorch. In parallel, statistical measurements such as NDVI or NDRE values, LiDAR-derived slope or openness, and thermal ΔT values are ingested by tabular models such as gradient boosting machines or multilayer perceptrons. These two streams—visual and statistical—may operate independently or may be fused. In early fusion, the features are concatenated into a single vector prior to classification, allowing the model to consider spectral, spatial, and thermal attributes simultaneously. In late fusion, independent outputs from the visual and statistical models are combined by rule-based logic or learned weights, ensuring that only detections corroborated by multiple modalities are marked. The flexibility to employ early or late fusion is a deliberate design choice of the invention, providing adaptability to different data environments.

The invention also incorporates a feedback mechanism wherein outputs from validation runs are cycled back into the ground-truth dataset to strengthen future training. For example, if a detection is consistently made across folds but was not originally annotated, operators may review it and, if confirmed, add it as a new annotation. This iterative feedback loop enriches the ground-truth dataset over time, creating a self-reinforcing cycle of learning. With each iteration, the model not only improves on the current AOI but also becomes more generalizable across future AOIs, making the exported trained model a reusable tool rather than a one-off solution.

The computer system tracks all of these steps by writing metadata for each training session into memory. This metadata includes training epoch counts, validation accuracy, loss function convergence, augmentation parameters applied, and hyperparameter settings. By storing this information, the system creates an audit trail that allows reproducibility. If the same data and parameters are presented again, the system will produce the same trained model artifact. This traceability is critical not only for scientific rigor but also for ensuring confidence in culturally sensitive applications such as cemetery investigations, where repeatability and transparency are essential.

Upon completion of training, the invention produces two principal outputs. The first is the annotated AOI pixel map, where detections are marked with bounding polygons or centroids linked to class labels, confidence scores, and supporting spectral or elevation statistics. This annotated map exists as a digital object in GIS-compatible formats, allowing direct visualization by archaeologists, planners, or community stakeholders. The second output is the trained machine learning model itself, exported as an artifact—preferably in the Open Neural Network Exchange (ONNX) format. This artifact embodies the learned parameters, fusion logic, and validation thresholds developed during training. It can be stored, transferred, and deployed across different computing environments, making the invention not merely a process that ends with one map but a tool that can be rerun on new AOIs to automatically detect archaeological features of interest.

The significance of producing a trained model artifact at this stage cannot be overstated. Whereas traditional approaches yield only static reports or maps, this invention generates a reusable digital tool that can be applied repeatedly to future datasets. Once trained, the model can be deployed on entirely new AOIs, ingesting fresh pixel maps and applying the learned detection logic to identify features automatically. This portability transforms the invention from a single-site workflow into a general-purpose detection apparatus capable of scaling across projects, regions, and contexts. In this way, the invention turns iterative training into an investment: every new AOI and every new annotation enriches the tool, expanding its utility for future work.

By the close of this first segment, the invention has completed its preparatory and training stages. It has transformed raw datasets into structured AOI pixel maps (FIG. 1), subdivided them into tiles for modular analysis (FIG. 2), annotated and augmented them to create diverse and realistic training samples, accelerated its accuracy through a super-linear learning curve (FIG. 9), and partitioned them into subsets for rigorous training and validation. It has cycled through iterative training loops, fused visual and statistical information, reinforced its models with feedback, tracked its own process through metadata, and produced both an annotated map and an exportable ONNX-trained model. These accomplishments establish the invention not merely as a data processing pipeline but as a complete computer-implemented tool for automatic detection of archaeological features, with graves emphasized as the validated exemplar.

Once the AOI pixel map has been constructed and subdivided into tiles, and once annotations, augmentation, and iterative training cycles have been established as described previously, the invention proceeds to modality-specific processing. Each sensing modality provides unique and complementary information, and the system is designed to ingest them in parallel while treating each as an independent evidence stream. The following instructional description sets out how the invention handles RGB imagery, multispectral and hyperspectral imagery, thermal sensing, and LiDAR, before converging their outputs through fusion and validation.

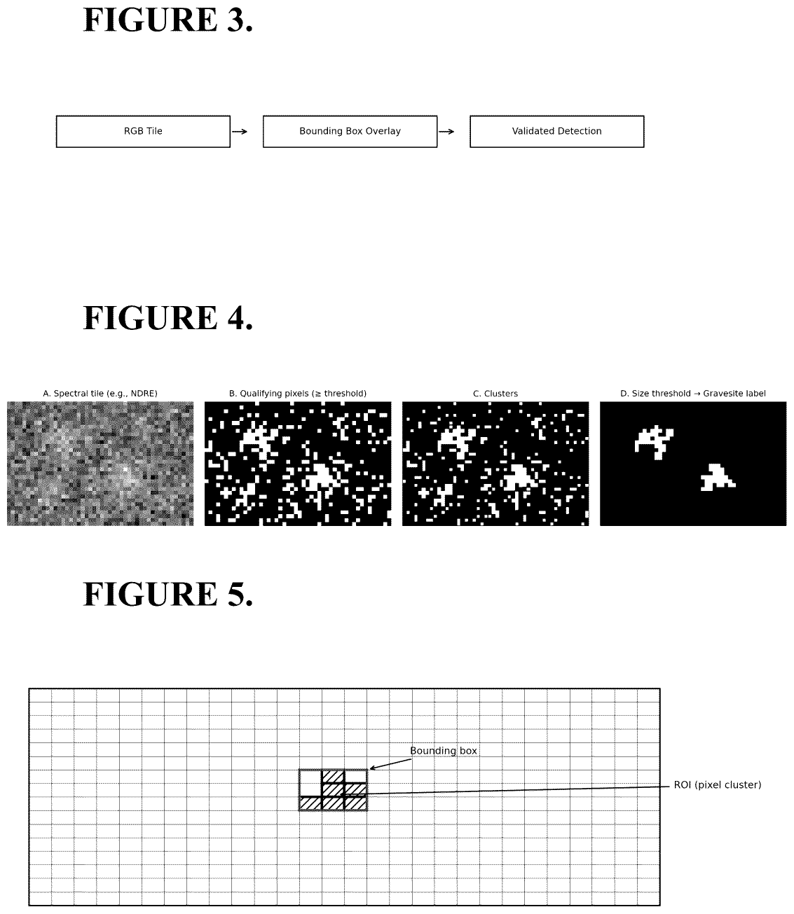

The first modality is RGB photogrammetry, the most familiar form of remote sensing. As depicted in FIG. 1, RGB imagery enters the system alongside other modalities, and once orthorectified and mosaicked, it becomes a layer in the AOI pixel map. Each pixel in the RGB layer carries three representative values: red, green, and blue intensity. These values are aligned with AOI coordinates and stored in memory. When subdivided into tiles (FIG. 2), the RGB imagery provides the system with high-resolution visual context. Human operators often begin annotation on RGB tiles, marking headstones, crosses, or other visible markers. As illustrated in FIG. 5, such annotations are stored as pixel clusters enclosed by bounding boxes, forming regions of interest (ROIs). Once trained, the machine learning models are able to replicate this logic automatically, as shown in FIG. 3. In that figure, an RGB tile enters the detection workflow, bounding boxes are overlaid by the model, and validated detections are marked. RGB therefore provides a direct visual channel: features are recognized based on edges, texture, shadow, and shape. While RGB alone can detect surface markers, it is not sufficient for subsurface or indirect anomalies, and so it is fused with the additional modalities described below.

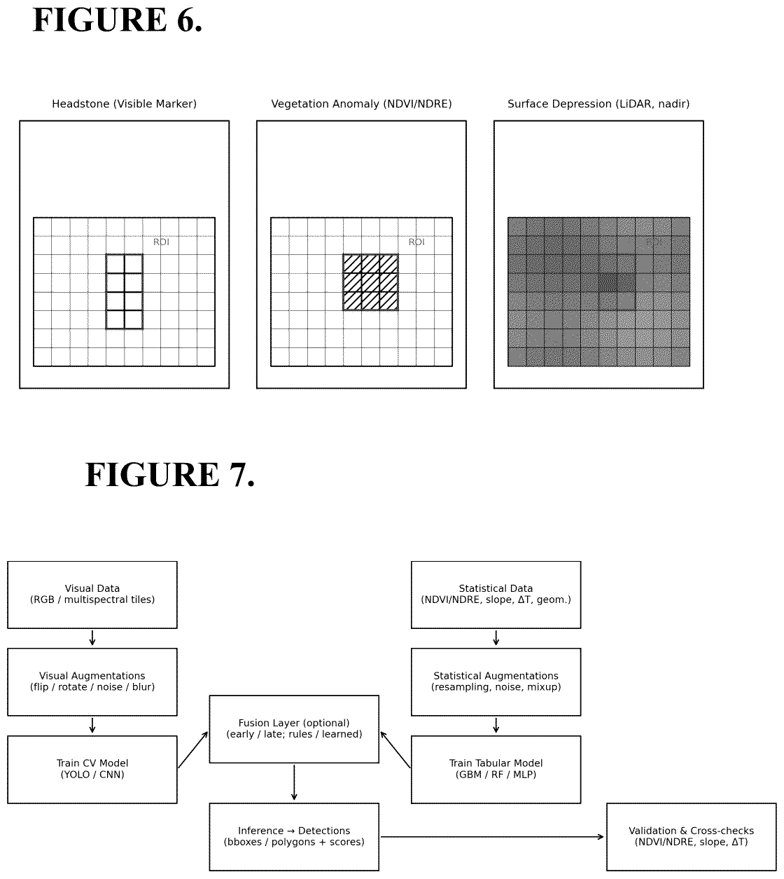

The second modality is multispectral and hyperspectral imagery, which provide spectral values beyond the visible bands. These inputs, also depicted in FIG. 1, are written into the AOI pixel map as arrays where each pixel may carry values from near-infrared, red-edge, or many narrow contiguous bands. These values are not merely colour differences; they are proxies for plant physiology and soil chemistry. The system computes indices such as NDVI (Normalized Difference Vegetation Index) and NDRE (Normalized Difference Red Edge) from these pixel values, storing them as derived arrays aligned with AOI coordinates. In practice, gravesites often cause elevated NDVI and NDRE values due to enriched vegetation over disturbed soils. As illustrated in FIG. 4, the system thresholds spectral tiles to identify qualifying pixels, clusters those pixels into contiguous regions, and applies size filters to retain only grave-sized anomalies. The result is a set of candidate clusters marked as vegetation anomalies. These clusters may be confirmed against labeled examples in FIG. 6, where one of the nadir views illustrates vegetation enrichment as a recognizable ROI. Multispectral and hyperspectral channels therefore provide the system with indirect evidence: not markers themselves but biological responses to underlying burial activity.

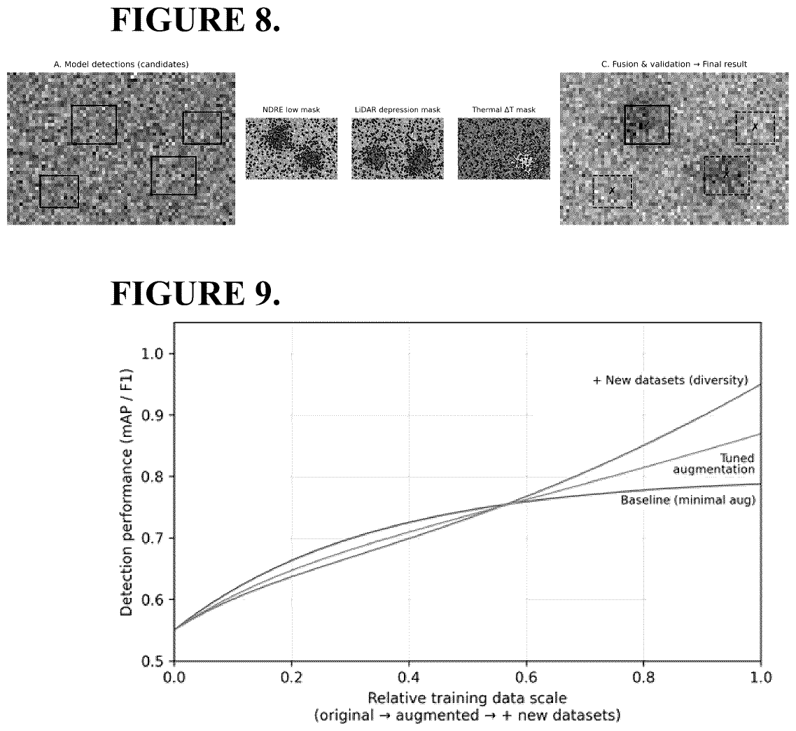

The third modality is thermal sensing, which contributes a different but equally valuable stream of information. As shown in FIG. 1, thermal imagery is ingested into the AOI pixel map as arrays of emissivity or brightness temperature values, aligned by coordinate. Thermal data may also be differenced between acquisitions at different times of day, producing ΔT rasters that capture diurnal temperature variation. Burials often alter soil compaction and moisture, which in turn affect thermal retention. The system stores thermal values in AOI arrays and analyzes them for anomalies. As part of clustering, pixels with emissivity values significantly different from background are grouped, forming candidate clusters of thermal anomalies. These anomalies are cross-validated later against spectral and elevation evidence. When displayed in annotation workflows, thermal anomalies can be linked to ROIs, expanding the ground-truth dataset. While thermal alone is not decisive, when combined with NDRE enrichment or LiDAR depressions it becomes powerful evidence, as shown schematically in FIG. 8, where thermal masks are one of the binary evidence layers used for validation.

The fourth modality is LiDAR, which provides high-resolution three-dimensional geometry of the terrain. As illustrated in FIG. 1, LiDAR enters the system as dense point clouds, which the processor filters using algorithms such as cloth simulation filtering to separate ground from non-ground returns. Ground points are then interpolated into raster maps such as digital elevation models (DEMs) or digital terrain models (DTMs) that embed representative values of height. These rasters are stored in memory as AOI arrays, aligned with other modalities. The LiDAR height raster is particularly useful for identifying shallow depressions or mounds consistent with graves. The processor derives additional layers such as slope, hillshade, sky-view factor, and openness from the DEM/DTM. These derivatives accentuate concavities and microtopographic features. Clustering is applied to group pixels forming elongated depressions or circular mounds. In FIG. 6, one of the labeled nadir examples illustrates a LiDAR-derived depression as an ROI, demonstrating how annotations span across modalities. LiDAR-derived anomalies are therefore stored as clusters that may later be confirmed or rejected during fusion and validation.

At this stage, each modality has contributed clusters of candidate anomalies. RGB provides bounding boxes around visible markers (FIG. 3). Multispectral and hyperspectral imagery provide spectral anomaly clusters (FIG. 4, FIG. 6). Thermal imagery provides emissivity anomaly clusters (FIG. 8). LiDAR provides elevation anomaly clusters (FIG. 6 again). Each of these candidate detections is stored digitally in memory, indexed to AOI coordinates, and accompanied by metadata describing its modality and supporting values. These clusters now await the fusion and validation logic described in subsequent sections, where they will be tested against one another to confirm or reject archaeological features of interest.

Once candidate anomalies have been identified within each modality, the invention advances to the critical stage of fusion and validation, where detections are tested, combined, and either accepted or rejected as archaeological features of interest. This is where the invention's multi-modal character is most apparent: no single modality is treated as decisive, but rather as one stream of evidence that must be corroborated by others before a final detection is marked.

The system operates on the principle that true archaeological features will express themselves across modalities, even if subtly. For example, a burial shaft may appear in RGB as a faint discoloration, in multispectral data as elevated NDRE values, in LiDAR as a shallow depression, and in thermal imagery as a cooling anomaly. Conversely, a random vegetation patch may appear in RGB and NDVI but will not correspond to a LiDAR depression or a thermal anomaly. The system's validation step is designed to distinguish between these cases.

As shown schematically in FIG. 7, the system ingests evidence through two parallel pathways: a visual learning path and a statistical learning path. The visual path processes tiled imagery (RGB, multispectral composites) through convolutional neural networks such as YOLO-family detectors implemented in PyTorch. The statistical path processes numerical features (NDVI means, NDRE variances, LiDAR slope values, thermal ΔT anomalies) through tabular models such as gradient boosting or random forests. Each path may output independent detections, but these detections are not final. Instead, the outputs are passed into a fusion layer. In early fusion, features are concatenated before classification; in late fusion, outputs are combined by learned weights or explicit rules. Both approaches are supported within the invention.

The fusion process is then subject to validation against binary evidence masks derived from independent modalities, as illustrated in FIG. 8. For example, detections from the YOLO model may be compared to NDRE masks thresholded to highlight vegetation enrichment. If bounding boxes overlap significantly with these masks, the detection confidence is upgraded. If they do not overlap, the detection may be rejected, regardless of neural network confidence. Similarly, candidate detections are compared against LiDAR depression masks and thermal anomaly masks. Detections that overlap with two or more independent evidence layers are upgraded to validated status. Detections that overlap only one layer may be retained provisionally if confidence is high. Detections that overlap none are rejected. This cross-validation ensures that outputs are anchored in physical evidence, not just algorithmic pattern recognition.

In addition to validation, the system applies verification filtering to reduce false positives. Verification filtering compares validated detections against a library of non-target features that can mimic graves but are not of archaeological interest. These may include rocks, tree-throw pits, animal burrows, or cultural debris piles. The verification filter may be rule-based, rejecting detections with geometric properties inconsistent with graves (e.g., circular mounds when elongated depressions are expected), or statistical, rejecting detections with spectral variability inconsistent with decomposition enrichment. The filter may also be trained as a negative-class model, ingesting examples of non-targets and learning to exclude them automatically. By applying verification filtering after validation, the system ensures that final outputs represent true archaeological anomalies with a high degree of precision.

A critical component of the invention is the treatment of LiDAR height rasters. Raw LiDAR point clouds contain both ground and non-ground returns, including vegetation, buildings, and noise. To use LiDAR effectively, the system must identify the “true ground” surface. This is achieved through the Cloth Simulation Filter (CSF), which inverts the point cloud and drapes a virtual mesh cloth over it. Points falling above the cloth are classified as non-ground, while those beneath it are retained as ground. The CSF has several tunable parameters: cloth resolution, iteration cycles, and classification threshold. The invention specifies that these parameters must be dialed in carefully to preserve shallow depressions while filtering vegetation. For example, cloth resolutions in the range of 0.4-0.6, iteration cycles between 600 and 900, and classification thresholds near 0.8-1.2 are typically effective in cemetery contexts. These ranges are not rigid but are empirically validated, and they ensure that subtle depressions, such as those created by graves, are preserved. Once classified, ground points are interpolated into DEMs and DTMs, rasterized at cell sizes of 0.1-0.25 meters to capture micro-relief. From these raster maps, derivatives such as slope, hillshade, sky-view factor, and openness are computed. These derivatives highlight depressions and concavities consistent with graves.

LiDAR-derived anomalies are then clustered into candidate features. Elongated depressions aligned in rows may correspond to burial shafts, while circular mounds may correspond to tumuli. As illustrated in FIG. 6, labeled nadir examples demonstrate how a LiDAR depression appears as an ROI, alongside vegetation anomalies and visible markers. These LiDAR anomalies are not accepted in isolation; they are validated against spectral and thermal evidence in the fusion stage. Only when corroborated across modalities do they become marked features.

Spectral indices, particularly NDVI and NDRE, are also integrated into predictive modeling and quantification. As explained in FIG. 4, NDVI and NDRE values are thresholded to identify qualifying pixels, which are clustered into anomalies and filtered by size. NDVI means in the range of 0.59-0.70 and NDRE means in the range of 0.14-0.25 are often observed in graves, with NDRE typically showing lower within-polygon variance. These ranges are not rigid but are treated as normalized intervals that can be applied across regions. The system is therefore able to recognize graves not only at one site but across different environments, because the indices are normalized ratios. In predictive modeling, the system uses NDVI and NDRE values not only as validation criteria but also as predictors for the number of graves. For each validated cluster, the system calculates mean NDVI and NDRE, compares them to normalized ranges, and applies a unit feature size parameter to estimate counts. These counts are stored in metadata and linked to detections. In this way, the invention does not simply identify graves but quantifies them.

Normalization is essential for transferability. By using indices like NDVI and NDRE, which are inherently normalized, and by standardizing grave dimensions through unit feature size parameters, the invention ensures that its models can operate consistently across regions. A model trained in one cemetery can be applied in another, because the detection logic is based on normalized biological and geometric signals rather than absolute values. This capability transforms the invention into a globally applicable tool.

As detections move through fusion, validation, clustering, and verification filtering, the system produces final outputs. Clusters that pass all checks are marked digitally on the AOI pixel map with polygons, centroids, or bounding boxes. Each marked feature carries metadata: modality evidence, NDVI and NDRE means, LiDAR depression metrics, thermal anomalies, unit feature size estimates, and grave counts. As illustrated in FIG. 3, bounding boxes are overlaid on RGB tiles, producing validated detections. As shown in FIG. 8, detections are compared against binary evidence masks, with accepted and rejected results. The final output is an annotated AOI pixel map, exportable as GIS layers, and a trained ONNX model artifact encapsulating the detection logic.

By the time the system has completed its fusion, validation, verification, and quantification processes, it has not only identified individual features of interest within the AOI but has also produced a tool that can be applied again and again across contexts. This invention is embodied in two interlinked forms: the annotated process and the trained model artifact, preferably exported in ONNX format. The annotated process protects and demonstrates the results of the iterative process—compounding augmentation of datasets to classify and delineate polygons and bounding boxes marking validated features, each accompanied by metadata describing spectral ranges, LiDAR metrics, thermal anomalies, and unit feature size calculations. The ONNX model artifact embodies the detection logic itself—a trained neural network and decision structure that can be deployed on entirely new AOIs. Together, these outputs turn the invention from a one-time analysis pipeline into a reusable apparatus for automatic archaeological feature detection.

In practice, this means that a community, researcher, or agency equipped with the invention can repeatedly apply it to new projects for auto-detection. Once a model has been trained on initial annotated AOIs, it can be exported and reapplied to new sites, ingesting fresh datasets and marking features automatically. If new annotations are later added, the model can be retrained iteratively, producing updated ONNX artifacts with improved accuracy. In this way, the invention is not static but self-strengthening: every new deployment makes it better. Over time, as AOIs from different regions are processed, the system builds a generalized logic that recognizes graves and archaeological features across environments—prairie, forest, desert, urban margins—because its foundations rest on normalized indices (NDVI, NDRE), standardized dimensions, and cross-modal validation.

The benefit of this invention in the real world is profound. In archaeological practice, it replaces weeks or months of manual interpretation with automated detection carried out in hours. In cultural heritage management, it allows caretakers to map cemeteries, including unmarked graves, with accuracy and without disturbing the ground. In reconciliation contexts, it gives Indigenous communities a scientific, non-invasive method for locating missing children and lost ancestors at former residential school sites, ensuring cultural respect while providing actionable evidence. In humanitarian and forensic contexts, the system allows rapid detection of clandestine or mass graves in conflict zones, where time is critical and excavation may be unsafe. In infrastructure planning, the tool can scan proposed corridors for burial sites and archaeological features, preventing costly delays and irreversible damage. Across all of these contexts, the invention serves not only as a technical pipeline but as an enabler of informed decision-making and ethical practice.

The technical benefits are equally clear. By fusing modalities, the system ensures that detections are validated by multiple independent signals, reducing false positives and increasing trust. By applying augmentation, it accelerates its own learning curve, achieving parabolic improvements in accuracy that make it viable for real-world deployment with limited datasets. By using standardized unit feature sizes and normalized spectral indices, it produces results that are transferable across regions and cultures. By tracking every step with metadata, it produces outputs that are transparent and auditable, ensuring scientific rigor and cultural accountability. By exporting trained models in ONNX format, it allows portability and reuse, turning each trained detector into a tool that can be deployed by communities, researchers, or agencies anywhere in the world.

The invention also introduces a new way of thinking about archaeological detection: it is not merely about producing maps, but about building a digital instrument that learns, adapts, and improves with use. Just as a total station or GPS unit revolutionized field mapping in the twentieth century, this invention introduces a twenty-first century equivalent: a machine learning apparatus that can be carried from site to site, ingesting new datasets and producing validated detections automatically. Once trained, the tool functions like an “archaeological sensor” in its own right, one that does not measure light or distance directly but interprets data streams through learned logic, marking graves and features as if they were directly observed.

As a practical matter, the system reduces cost, saves time, and preserves dignity. Excavation, probing, and geophysical testing are intrusive, expensive, and often culturally unacceptable. Manual interpretation of imagery is slow and subjective. This invention allows features to be identified digitally, non-invasively, transparently, and reproducibly. The annotated AOI maps it produces can be handed to archaeologists, Indigenous communities, or planning agencies as GIS-ready files. The ONNX models it exports can be distributed and reused, ensuring that knowledge gained in one project benefits the next. In this way, the invention scales knowledge—it creates not just results, but a growing body of detection capability that travels forward in time.

In its final embodiment, the invention is a systematic apparatus for converting remote sensing into actionable archaeological intelligence. It is a structured workflow and pipeline that transforms pixels into knowledge, annotations into logic, and trained models into usable digital tools. It is simultaneously a method, a procedure, and a digital artifact that enables non-invasive, repeatable, and scalable investigation of graves and archaeological features.

It stands as a new instrument for archaeology, cultural heritage, and humanitarian investigation, enabling the precise detection and definition of features of interest in full alignment with their physical environmental and cultural context.

The following excerpts are adapted from the applicant's graduate thesis (Kuncewicz, N. A. (2025). Tools from above: Evaluating drone-borne aerial remote sensing systems for archaeological site and feature identification [Master's thesis, Lakehead University]. Knowledge Commons, which is hereby incorporated by reference. They are included not as independent procedures, but as subset examples illustrating how parameterized indices and point-cloud filtering workflows can be tuned to optimize inputs for machine learning pipelines. In particular, vegetation indices such as NDVI and NDRE, along with LiDAR classification routines such as the Cloth Simulation Filter (CSF), demonstrate how statistical ranges, thresholds, and feature-size distributions can be dialed in to refine datasets for training and iterative model improvement. While elements such as “Step 19” reflect their original academic framing, in the present context they are reinterpreted as adjustable modules within a broader AI-driven system, supporting augmentation, validation, and predictive capacity across multispectral, thermal, and elevation data sources.

Subsection a. In one illustrative embodiment, the system may utilize multispectral optical data to identify human burials by filtering spectral values known to be significant in archaeological contexts extending back as much as 150 years. For example, NDVI and NDRE ranges can be used to exclude values outside expected reflectance thresholds, while statistical measures of average grave size (e.g., male, female, adult, sub-adult, infant, or mortuary context) may be incorporated. These values can be normalized against ground sampling distance (GSD) to provide scale-appropriate estimates. While the underlying equations originate from the applicant's graduate thesis, in the present context they serve as examples of how vegetation indices can be parameterized to refine datasets prior to ingestion by the AI pipeline. Importantly, such parameters are adjustable and are not limiting, but instead demonstrate one way in which multispectral indices can be optimized for predictive modeling.

$$S 0 ∼ {}_{\vert}^{\vert} ( {r}_{NDVI} - {r}_{NDRE} ) + ( - 1 - {r}_{NDRE} ) + ( 1 - {r}_{NDVI} ) \\ S 1 ∼ {}_{\vert}^{\vert} ( avg [ {r}_{NDVI} ] - avg [ {r}_{NDRE} ] ) + ( - 1 - avg [ {r}_{NDRE} ] ) + ( 1 - avg [ {r}_{NDVI} ] ) + C of \frac{AFS}{GSD / 10000} \times 0.5 \\ S 2 ∼ {}_{\vert}^{\vert} Min NDVI - Max NDRE + - 1 - min NDRE + 1 - Max NDVI + C of \frac{AFS}{GSD / 10000} \times 0.5$$

Related to this spectral relevance hierarchy, the system may also be configured to estimate the number of graves in a dataset through a frequency-based method. This approach begins with the relationship between ground sampling distance and average feature size, which together establish the expected number of pixels that typically represent a grave. Once the average pixels per feature have been determined, the frequency of candidate anomalies exhibiting grave-like reflectance is calculated from the histogram distribution of NDVI or NDRE values. By dividing the observed frequency of these anomalies by the expected pixel count per grave, the system can produce an estimate of the total number of graves present in the dataset. While this method is adaptable to both NDVI and NDRE indices, NDRE has been shown to provide greater sensitivity to nutrient and chlorophyll variations linked to decomposition processes, and therefore often results in a more reliable estimate. These estimates may be accompanied by confidence intervals derived from varying the assumed feature size or by resampling background distributions, enabling the system to provide not only detection and confidence scoring of anomalies but also a statistically grounded estimate of their overall prevalence within the dataset.

$$\frac{AFS}{GSD / 10000} \to \frac{Frequency}{APPF} = Estimate of Graves per Dataset$$

Legend to the above equations:
S0=Unsuccessful (Success 0)
S1=Successful Anomaly based on Average (Mean) of Range
S2=Successful Anomaly based on Min/Max
˜=Approximate
¦=Function of
avg=Average
r=Range
NDVI=Normalized Difference Vegetation Index
NDRE=Normalized Difference RedEdge Index
C=Cluster
AFS=Average Feature Size
GSD=Ground Sampling Distance
F=Frequency
APPF=Average Pixels Per Feature
EGD=Estimate of Graves per Dataset

Subsection b. In another possible embodiment, hyperspectral acquisition is used to densely sample the Near-Infrared (NIR) and Red-Edge spectral regions, which are the foundational signals leveraged by this invention. Both multispectral and hyperspectral implementations rely on vegetation responses in these regions (e.g., chlorophyll and nitrogen-related changes) as the core spectral basis for detection. Hyperspectral systems, however, provide hundreds or thousands of narrow bands spanning and adjacent to NIR and Red-Edge, offering the potential for much finer tuning of thresholds and model parameters. Over time, such dense spectral coverage may also enable detection of specific isotopic signatures—such as nitrogen-15 enrichment tied to human trophic level consumption—that could, in theory, yield a direct and highly accurate confirmation of human burials of up to 100% confidence.

Subsection c. The system may further incorporate LiDAR-derived datasets. In one example, a raw .LAS file can be processed using open-source tools such as CloudCompare and QGIS, with the Cloth Simulation Filter (CSF) algorithm applied to distinguish ground from non-ground points. This process simulates a virtual cloth draping over inverted point clouds, enabling terrain surface modeling and subsequent anomaly detection. Parameters such as altitude, cloth resolution, max iterations, and classification thresholds can be tuned according to dataset resolution. While one example combination includes 45-60 m altitude, <10 cm GSD, cloth resolution of 0.5, 750 iterations, and a classification threshold of 1, these values are provided only as reference.

Because CSF performance is directly tied to GSD, parameters must be adapted depending on whether data is acquired from drones, manned aircraft, or satellites. For burial-scale anomalies, effective raster resolutions generally fall between 0.1-0.25 m (for statistical detection) and 0.25-0.5 m (for visual interpretability). Below this range, outputs may become overly fine-grained, while above it anomalies may appear blocky or distorted. This example underscores how LiDAR filtering and visualization parameters can be flexibly dialed in to detect microtopographic changes relevant to graves and similar archaeological features, while still supporting broader ML training workflows.

How the CSF Algorithm Works:

The algorithm starts by inverting the point cloud, so the lowest points (which typically correspond to the ground) are the highest. A virtual “cloth” is then draped over this inverted point cloud, settling on the highest (lowest in the original cloud) points first. The cloth can adapt to various terrain types, effectively modeling the ground surface. Once the cloth has settled, points in the original point cloud that lie close to the cloth are classified as ground points, while those that lie above a certain threshold are classified as non-ground points.

Adjustable Parameters in CSF:

Cloth Resolution: This parameter defines the grid size of the cloth mesh. It controls the density of the cloth, which in turn affects the level of detail the cloth can conform to.

Low resolution: The cloth will have fewer points, making it smoother and less sensitive to small variations in the terrain.

High resolution: The cloth will have more points, allowing it to conform more closely to detailed features of the terrain.

Max Iterations: This sets the maximum number of iterations the algorithm will perform to adjust the cloth until it settles.

Fewer iterations: Faster processing but may result in an incomplete or less accurate simulation.

More iterations: Slower processing but can result in a more accurate separation of ground and non-ground points, especially in complex terrains.

Classification Threshold (Threshold Distance): This parameter defines the maximum distance between a point in the original point cloud and the settled cloth to consider the point as part of the ground.

Lower threshold: More points will be classified as non-ground, possibly excluding some ground points (useful in highly detailed or rugged terrains).

Higher threshold: More points will be classified as ground, which might include some non-ground points (useful for flatter terrains).

Feature Visibility: Certain settings, when carefully tuned, can make specific features of a certain size and shape more visible. For instance, if you are searching for features like small depressions such as unmarked graves or small raised areas, you might need a specific combination of lower altitude (for higher resolution) and high cloth resolution to reveal these features.

Obscuring Features: If the settings are not optimal (e.g., high altitude with low cloth resolution), the same features may become obscured, appearing as part of the general terrain or being completely undetectable.

The relationship between altitude (affecting GSD) and parameters like cloth resolution in the CSF can significantly impact the visibility of certain features in the processed data. By dialing in specific settings based on the desired feature size and shape, you can either enhance the visibility of these features or obscure them. In practice, this means that careful calibration of both the altitude of the LiDAR/drone system and the CSF parameters is crucial when targeting the detection of specific types of terrain features.

This results in a raster digital elevation model (DEM) using the step function in CloudCompare set to ˜ the same GSD as the input point cloud. The raster DEM is then subject to various shading algorithms, terrain visualization algorithms, and terrain analysis algorithms in a combination call visualization for archaeological topography (VAT) that is also a plugin for QGIS. This raster is run through the VAT tool using the suggested pre-sets.

Effectively, this patented tool would be developed as a web-based application where consumers of this product can import raw multispectral data and run the algorithm-based tool that makes use of the formulae to reveal high probability areas associated with human graves based on spectral signatures.

Since various modifications can be made in the invention as herein above described, and many apparently widely different embodiments of same made, it is intended that all matter contained in the accompanying specification shall be interpreted as illustrative only and not in a limiting sense.

1. A method of identifying an archeological feature of interest in an area of ground, the method comprising:
acquiring one or more remotely sensed datasets representing said area of ground;
creating a representative map of said area of ground from the one or more remotely sensed datasets in which the representative map comprising an array of representative values which represent a measured characteristic at a respective coordinate of said area of ground;
comparing clusters of the representative values which are similar to one another to feature criteria to determine if the clusters each represent the archeological feature of interest; and
marking the clusters determined to be archeological features of interest on a map for display to a user.

2. The method according to claim 1 further comprising generating a display map of said area of ground including an indication of each cluster identified as the archeological feature of interest on the display map.

3. The method according to claim 1 wherein the archeological feature of interest is a gravesite.

4. The method according to claim 1 wherein the remotely sensed datasets comprise multispectral images and said representative map comprise a pixel map defining a pixel at each coordinate, the method further comprising:
creating said representative map by calculating a vegetation index in which each pixel from the pixel map defines a reflectance value associated with the pixel; and
comparing said clusters to said feature criteria to determine if the clusters each represent the archeological feature of interest by:
(i) for each pixel, comparing the reflectance value to a reflectance threshold and determining the pixel to be a qualifying pixel if the reflectance threshold is met or a non-qualifying pixel if the threshold is not met;
(ii) identifying clusters of adjacent qualifying pixels; and
(iii) comparing each cluster of adjacent qualifying pixels to a size threshold and determining the cluster to be a gravesite if the size threshold is met or to be a non-gravesite if the size threshold is not met.

5. The method according to claim 4 wherein the vegetation index comprises (i) NDVI (Normalized Difference Vegetation Index), a normalized reflectance index empirically validated to exhibit elevated mean values over gravesites compared to background vegetation, (ii) NDRE (Normalized Difference Red Edge), an index sensitive to nitrogen enrichment and chlorophyll density, validated as a reliable proxy for vegetation anomalies associated with graves or (iii) both NDVI and NDRE, the combined indices providing a dual measure of vegetation vigor and nutrient enrichment that increases stability and reduces false positives in burial detection.

6. The method according to claim 4 further comprising adjusting the reflectance thresholds dynamically during validation, wherein augmentation includes variable lighting, vegetation state, and terrain distortion.

7. The method according to claim 4 further comprising calculating the size threshold based on a ground sampling distance associated with the acquired images.

8. The method according to claim 4 further comprising selecting the size threshold among a plurality of different size thresholds associated with different burial dimensions.

9. The method according to claim 4 further comprising creating the pixel map by stitching together a plurality of the acquired images associated with different sections of said area of ground.

10. The method according to claim 4 further comprising calculating a total number of graves within said area of ground by dividing a number of the qualifying pixels in clusters by a unit value representative of a size of a single grave.

11. The method according to claim 10 further comprising selecting the unit value among a plurality of different unit values associated with different corpse sizes.

12. The method according to claim 10 further comprising calculating the total number of graves within said area of ground using a frequency distribution of the average reflectance of vegetation within a human grave plotted on a histogram by dividing the frequency by the unit value which represents an average feature size.

13. The method according to claim 10 further comprising calculating burial density by plotting the average reflectance of vegetation associated with gravesites on a histogram and dividing the frequency distribution by a unit value representing average feature size.

14. The method according to claim 10 wherein statistical measurements for estimating burial density comprise NDVI, NDRE or both NDVI and NDRE enabling enhanced stability in quantifying burial densities.

15. The method according to claim 1 wherein the remotely sensed datasets comprise remotely sensed elevation data comprising a discrete set of data points in space defining the area of ground in Cartesian coordinates comprising an elevation, a latitude, and a longitude associated with each data point, the method further comprising:
creating said representative map by filtering the set of data points to remove any data points determined to be non-ground points based on an anomalous elevation and replacing the removed data points within the set of data points with replacement data points representing true ground; and
comparing said clusters to said feature criteria to determine if the clusters each represent the archeological feature of interest by:
(i) for each data point of the set of data points, calculating a plurality of elevation attributes that define a relationship between the elevation of the data point and the elevation of laterally and longitudinally adjacent data points;
(ii) clustering data points having similar elevation attributes into clusters; and
(iii) comparing each cluster to a size threshold and determining the cluster to be a gravesite if the size threshold is met or to be a non-gravesite if the size threshold is not met.

16. The method of claim 15 further comprising acquiring LiDAR point cloud data of the area of ground, classifying ground points, rasterizing into elevation models, and calculating elevation attributes including hillshade, slope gradient, skyview factor, and openness, clustering anomalies consistent with burial features, and validating said anomalies in combination with spectral and thermal detections.

17. The method according to claim 15 including determining data points to be non-ground points when the elevation is above an upper threshold or below a lower threshold.

18. The method according to claim 15 wherein the replacement data points representing true ground are calculated by interpolating the elevations from laterally and longitudinally adjacent data points.

19. The method according to claim 15 including rasterizing the set of data points prior to calculating the elevation attributes.

20. The method according to claim 15 including filtering the set of data points to remove any data points determined to be non-ground points by applying a cloth simulation filter.

21. The method according to claim 20 including optimizing a cloth resolution, a maximum number of iterations, and a classification threshold of the cloth simulation filter to distinguish the gravesites from surrounding ground.

22. The method according to claim 20 including setting a cloth resolution of the cloth simulation filter to be between 0.4 and 0.6, setting a maximum number of iterations of the cloth simulation filter to be between 600 and 900, and setting a classification threshold of the cloth simulation filter to be between 0.8 and 1.2.

23. The method according to claim 15 wherein the elevation attributes include environmental attributes such as shading, gradient and openness of the data point relative to adjacent data points, for example hillshade, slope gradient, skyview factor, and/or positive or prismatic openness.

24. The method according to claim 15 including applying a verification filter by comparing the clusters to non-anomalous objects and removing any clusters identified as non-anomalous objects before marking the clusters on the map.

25. The method according to claim 1 wherein the datasets comprise at least one of RGB, multispectral, hyperspectral, LiDAR, thermal, or satellite imagery, whether captured directly or obtained from external sources and wherein the step of comparing said clusters to said feature criteria to determine if the clusters each represent the archeological feature of interest further comprises:
preprocessing the datasets into orthorectified and tiled image segments suitable for machine learning workflows;
training a machine learning pipeline to classify identified archaeological features in the datasets, the pipeline being configured to integrate visual information with statistical measurements derived from spectral, spatial, and thermal data;
performing inference on new datasets to automatically identify probable gravesites and archaeological features;
cross-validating detections against statistical thresholds and elevation or thermal anomalies; and
marking said clusters determined to be archeological features of interest on a map for display to a user by generating geospatial outputs marking validated features.

26. The method according to claim 25 further comprising importing the tiled datasets into annotation software, wherein human operators manually label regions of interest such as visible markers, vegetation anomalies, or surface depressions to generate ground-truth datasets for supervised machine learning.

27. The method according to claim 26 further comprising applying iterative augmentation to the labeled datasets, the augmentation including transformations selected from: horizontal flips, affine rotations within a range of −25 to +25 degrees, rescaling between 0.9 and 1.1, brightness variation between 0.8 and 1.2, contrast variation between 0.8 and 1.2, Gaussian noise addition with scale between 5 and 15, Gaussian blur with sigma between 0.0 and 1.0, and grayscale conversion applied with a probability of 30 percent.

28. The method according to claim 25 further comprising dividing the augmented datasets into training, validation, and testing subsets, wherein the subsets are used in a supervised learning workflow to optimize object detection accuracy and reduce model overfitting.

29. The method according to claim 25 further comprising training a machine learning model using the training subset, validating against the validation subset, and refining detection accuracy over multiple training-validation cycles, the model being configured to integrate RGB-derived features in combination with statistical tabular data including but not limited to multispectral or hyperspectral indices, LiDAR-derived height rasters, and thermal radiometric measurements.

30. An apparatus for identifying archeological features in an area of ground, the apparatus comprising:
a data source arranged to acquire one or more remotely sensed datasets representing said area of ground; and
a computer system comprising a processor and a memory storing programming instructions thereon arranged to be executed by the processor so as to be configured to perform the method according to claim 1
